(19) United States
(12) Patent Application Publication
(10) Pub. No.: US 2020/0387778 A1
(43) Pub. Date: Dec. 10, 2020

(54) Creating AI

(71) Applicant: Kevin Brian Delahoussaye, Ias Cruces, NM (US)

(72) Inventor: Kevin Brian Delahoussaye, Ias Cruces, NM (US)

(21) Appl. No.: 16/430,430

(22) Filed: Jun. 4, 2019

(51) Int. Cl. G06N 3/063

(52) U.S. Cl. CPC G06N 3/063

(57) ABSTRACT

Data is stored as mathematical constructions/patterns. this allows for improved storage by condensing data into a structure Impulses propagated through a neuron/microchip/diamond reanimate this stored information. When recalling information this mathematical construction is a logical piece of a puzzle which is the problem to be solved. When recalling information with many prorogations a dynamically fluid field is developed around the item of interest. Using current/signal information is passed through a set of “slits” a photon is used to control the sensors holding the category of information. When the sensor controlling the current gets the input to output is the electron and it will go through the “slits” the as determined by a input that is given to the laser controlling the photon. After this the electron/signal will get detected by a sensor and activate the information source inside. Many these set-ups will build a computer that can activate different information sources at the same time and contribute to the solving of different questions through the repetitive action of the steps outlined above.

To validate functional AI using data processing tech, mentioned above, and reinforcement through dopamine like code. Any AI can change how they process info and how their responses are rewarded/punished. Amended*

Storing info in a mathematical structure, crystals in humans, is a faster data processing technique. It allows for improvement on the structure and condenses information. Code can be created to allow the AI to do this. The goal is to reproduce the functional AI. Amended*

Using this method; the actual underlying chemistry of neurons. We can create a real AI. Any AI made in the future will be made using this method will be using the technology on this page. You are the agent of evolution, if you see something you do not like, remove it Amended*

### (F): DETAILED DESCRIPTION OF INVENTION

Open program of choice

Create an object

Allow object access to hard drive, ram, graphics gpu, and cpu
The hard drive is the library of information

Program linear thinking.
Like the semi-AI now it just does what it is told

Program abstract thinking.
Every corpuscle of anything can be broken down into data:
Instruct the object to store information as patterns. (Patterns of code will work) -Reinforce with dopamine like code Program encoding/retrieval:
Program so that the computer reads the stored raw info as logical patterns
During retrieval, the computer will access all of the patterns stored on the computer and its other sources

Program object to read incoming info as just a linear set of information
Complete the disc writing by turning this linear set of information into a pattern. The pattern of code is good.

Program Chaos Theory:
Variables without a connection and seeming chaos come together to form a pre-determined situation. Pre-determined situational chaos.
Add attractor: numerical values to which the system evolves.
Throw patterns at this situation and re-code as needed.

Program information processing:
Tell object to process problem by pattern throwing
Give the object a problem. It will “toss” patterns at it until you get the correct answer. Repeat many times with reinforcement/punishment and human intervention.

Allow the code to store what it wants on the hard drive and keep information lines open

Program Answer:
The answer must be given in statistical terms. Nothing can be said about anything unless you have performed a statistical analysis. The AI must be confident in its assertions.
Bayesian statistics is the best method for this. Every piece of learned/stored coming to the climax on one final decision.

The above steps when combined with an input/output system will create a fluid dynamic field, i.e. electric, capable of quiering information for the use of solving problems using quantum methods as described by the input/output system below.

Using current/signal information is passed through a set of “slits” a photon is used to control the sensors holding the category of information. When the sensor controlling the current gets the input to output is the electron and it will go through the “slits” the as determined by a input that is given to the laser controlling the photon. After this the electron/signal will get detected by a sensor and activate the information source inside. Many these set-ups will build a computer that can activate different information sources at the same time and contribute to the solving of different questions through the repetitive action of the steps outlined above.

1: data is stored as mathematical constructions/patterns. this allows for improved storage by condensing data into a structure which can be queried by inputs.

2: impulses propagated through an input/output system reanimate this stored information. When recalling information this mathematical construction is a logical piece of a puzzle which is the problem to be solved.

3: When recalling information with many iterations of inputs/outputs a dynamically fluid field is developed.
